(19) United States
(12) Patent Application Publication
(10) Pub. No.: US 2026/0280591 A1
(43) Pub. Date: Sep. 17, 2026

(54) METHOD FOR AMPLIFYING RADIO FREQUENCY SIGNAL UNDER MISMATCHED LOADS AND SYSTEM THEREOF

(71) Applicant: MICROLYNX SYSTEMS LTD., Calgary (CA)

(72) Inventor: Willem DURTLER, Calgary (CA)

(21) Appl. No.: 19/083,933

(22) Filed: Mar. 19, 2025

(30) Foreign Application Priority Data
Mar. 14, 2025 (CA) 3267806

(51) Int. Cl. H04B 1/04; H04B 1/00

(52) U.S. Cl. CPC H04B 1/04; H04B 1/0078; H04B 2001/045

(57) ABSTRACT

A system for a radio frequency power amplifier system is provided. The system includes a splitter configured to divide an input signal into a plurality of sub-inputs of same frequency and nominal amplitude, a first phase shift network configured to apply phase offsets to the sub-inputs, such that the sub-inputs are phase-shifted relative to each other, at least four parallel arranged sub-amplifiers, the parallel arranged sub-amplifiers configured to be driven by the sub-inputs and generate sub-outputs, a second phase shift network configured to apply the phase offsets inversely to the sub-outputs, such that a total phase offset is equivalent for each of the sub-amplifiers, and a combiner configured to combine the sub-outputs into an output signal. Each of the sub-amplifiers is presented with a different complex load impedance under mismatched load conditions.

### CROSS REFERENCE TO RELATED APPLICATIONS

This application claims the benefit of priority to Canadian Patent Application Serial Number 3,267,806 entitled “Method for Amplifying Radio Frequency Signal Under Mismatched Loads and System Thereof” filed Mar. 14, 2025, which is hereby incorporated by reference in its entirety.

### FIELD OF THE INVENTION

The present invention pertains to the field of radio frequency (RF) power amplification technology, specifically to systems and methods for amplifying radio frequency signal and maintaining stable power output under varying or mismatched load conditions.

### BACKGROUND OF THE INVENTION

Radio frequency (RF) power amplifiers are essential components in wireless communication and radar systems, enabling efficient transmission of signals over varying distances and conditions. The ability of a RF power amplifier to deliver consistent output power depends on several factors, including its load impedance, supply voltage, and circuit topology. In many applications, for example those involving antenna arrays, the load or impedance presented to the power amplifier can vary significantly, leading to substantial variations in output power. This variation can negatively impact system performance and cause component failures and degrade signal integrity.

Traditionally, RF power amplifiers have been designed to operate at a nominal impedance, for example 50 ohms, to ensure maximum power transfer and minimal reflections. However, real-world operating conditions introduce varying loads and impedance mismatches due to factors such as antenna detuning, environmental changes, and coupling effects in phased-array configurations. These mismatches can result in excessive power fluctuations, increased stress on amplifier components, and, in extreme cases, catastrophic failures.

Several conventional techniques have been employed to mitigate these issues. One known approach involves temporarily disabling the amplifier when impedance variations exceed predefined limits, thereby preventing damage but sacrificing transmission capability. Another method utilizes adaptive power control, wherein amplifier gain, input signal level, or power supply voltage is dynamically adjusted to manage power fluctuations. Adaptive power control can be used to limit maximum power by reducing the amplifier's gain, decreasing the input signal level, or lowering the power supply voltage. While this method may reduce excessive output power, it can be challenging to implement and can be prone to instability when the load varies. Additionally, this technique can be inherently restrictive, as it can only reduce power but cannot increase it when needed.

Balanced amplifier configurations, such as quadrature amplifiers, have been used to improve stability by reducing the impact of reflected signals. However, these systems primarily address reflection-related issues rather than power variations due to impedance changes. Additionally, traditional balanced designs still exhibit significant power spread when subjected to highly mismatched loads.

Accordingly, there may be a need for a method and apparatus for amplifying radio frequency signal under mismatch loads that is not subject to one or more limitations of the prior art.

This background information is intended to provide information that may be of possible relevance to the present invention. No admission is necessarily intended, nor should be construed, that any of the preceding information constitutes prior art against the present invention.

### SUMMARY

It is an object of the present disclosure to implement a power amplifier that can provide a controlled power output under widely varying mismatched load conditions.

To address these challenges, the present disclosure introduces an RF power amplifier system including multiple sub-amplifiers, each driven with a distinct phase shift to distribute the load variations more effectively. By leveraging phase-offset configurations and independent power regulation for each sub-amplifier, the method can minimize power fluctuations, enhance system efficiency, and improve reliability in demanding RF transmission environments. This approach can provide a robust solution for maintaining stable power output even in the presence of dynamic impedance mismatches, making it particularly suitable for high-power phased-array applications and other RF systems requiring precise power control.

According to an aspect, there is provided a radio frequency power amplifier system. The system includes a splitter configured to divide an input signal into a plurality of sub-inputs of same frequency and nominal amplitude and a first phase shift network configured to apply phase offsets to the sub-inputs, such that the sub-inputs are phase-shifted relative to each other. The system further includes at least four parallel arranged sub-amplifiers, the parallel arranged sub-amplifiers configured to be driven by the sub-inputs and generate sub-outputs. The system further includes a second phase shift network configured to apply the phase offsets inversely to the sub-outputs, such that a total phase offset is equivalent for each of the sub-amplifiers and a combiner configured to combine the sub-outputs into an output signal. Each of the sub-amplifiers is presented with a different complex load impedance under mismatched load conditions.

In some embodiments, the phase offsets are within the range of 0° to 135°, having a phase variation of nominally 0°-45°-90°-135°. In some embodiments, the phase offsets are with the range of 0° to 90°, having a phase variation of nominally 0°-30°-60°-90°.

In some embodiments, the output combiner includes an n-way combiner configured to aggregate the phase-shifted sub-outputs of the sub-amplifiers. In some embodiments, the combiner is configured as a cascaded two-way combiner or is implemented using quadrature hybrids.

In some embodiments, the splitter is configured as a cascaded two-way splitter or is implemented using quadrature hybrids.

In some embodiments, each of the sub-amplifiers includes a current-limiting power supply configured to provide constant voltage during high impedance loads and transition to constant current during low impedance loads.

In some embodiments, the system further includes an adaptive power control circuitry configured to adjust the voltages supplied to each of the sub-amplifiers based on sampling power of the output signal.

In some embodiments, the system further includes a directional coupler configured to distinguish between forward and reverse power, wherein forward power defined as RF power originating at the amplifier and terminating at the load, reverse power is defined as RF power originating at the load through reflecting or coupling and returning to the amplifier, and forward power is used as a metric for maintaining stable operation.

According to another aspect, there is provided a method for amplifying a radio frequency signal. The method includes dividing an input signal into at least four sub-inputs, each having the same frequency and nominal amplitude and applying phase offsets to the sub-inputs, such that the sub-inputs are phase-shifted relative to each other within a predefined phase variation. The method further includes amplifying each of the phase-shifted sub-inputs with a sub-amplifier to generate corresponding sub-outputs and applying phase offsets to the sub-outputs, such that the total phase offsets for each of the sub-inputs and the corresponding sub-outputs are equal. The method further includes combining the phase shifted sub-outputs of each of the sub-amplifiers to generate an output signal. Each of the sub-amplifiers is presented with a different complex load impedance under mismatched load conditions.

In some embodiments, the phase offsets are within the range of 0° to 135°, having a phase variation of 0°-45°-90°-135°. In some embodiments, the phase offsets are with the range of 0° to 90°, having a phase variation of 0°-30°-60°-90°.

In some embodiments, the dividing is performed by a cascaded two-way splitter or is implemented using quadrature hybrids. In some embodiments, the combining is performed by a cascaded two-way combiner or is implemented using quadrature hybrids.

In some embodiments, the method further includes providing power to each of the sub-amplifiers using a current-limiting power supply configured to provide constant voltage during high impedance loads and transition to constant current during low impedance loads.

In some embodiments, the method further includes sampling the output power of the combined output signal to generate a feedback control signal and adjusting the voltages supplied to each of the sub-amplifiers based on the feedback control signal to maintain a predetermined target power of the output signal.

In some embodiments, the method further includes iteratively adjusting the voltages of the sub-amplifiers to converge to the predetermined target power of the output signal.

In some embodiments, the method further includes adjusting the initial drain or collector voltage of each sub-amplifier individually to optimize efficiency and performance under varying load conditions.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

The present invention will now be more specifically described by way of example only with reference to the accompanying drawings.

FIG. 1 is a schematic diagram showing a known quadrature balanced amplifier.

FIG. 2 is a schematic diagram showing a generic quad-amplifier implementation according to an embodiment of the present disclosure.

FIG. 3a is a schematic diagram showing a quad-amplifier implementation utilizing a total of 135° phase offset, with an incremental offset of 45° between each sub-amplifier, according to an embodiment of the present disclosure.

FIG. 3b is a schematic diagram showing a quad-amplifier implementation utilizing a total of 90° phase offset, with an incremental offset of 30° between each sub-amplifier, according to an embodiment of the present disclosure.

FIG. 4 is a schematic diagram showing a practical quad-amplifier implementation using cascaded two-way splitters and combiners, according to an embodiment of the present disclosure.

FIG. 5a is a schematic diagram showing a practical quad-amplifier implementation using a four-way splitter and combiner, according to an embodiment of the present disclosure.

FIG. 5b is a schematic diagram showing a practical four-channel implementation with current-limiting power supplies, according to an embodiment of the present disclosure.

FIG. 5c is a schematic diagram showing a practical four-channel implementation with current-limiting power supplies and adaptive power control circuit, according to an embodiment of the present disclosure.

FIG. 6 illustrates a method for amplifying a radio frequency signal according to embodiments of the present disclosure.

### DETAILED DESCRIPTION

The following clearly and completely describes the technical solutions in the embodiments of the present disclosure with reference to the accompanying drawings. The described embodiments are merely some but not all of the embodiments of the present disclosure. All other embodiments based on the embodiments of the present disclosure and obtained by a person of ordinary skill in the art without investing creative efforts shall fall within the scope of the present disclosure.

In radio transmission systems, the ability to deliver high RF power to an antenna load is desired, with power amplifiers playing a critical role in this process. The power an amplifier can provide is largely governed by the drain voltage (V_{dd}) and the impedance (Z) seen at the amplifier stage, with power capability generally following a V_{dd}²/Z relationship. If the load impedance remains stable and well-defined, power delivery can be managed by adjusting the drain voltage and impedance transformation ratio. However, in real-world applications, impedance can vary significantly due to several factors, causing substantial fluctuations in transmitted power. Such variations can be especially problematic in broadband antennas, where impedance mismatches can occur at the edges of the operating frequency band, and in phased-array antenna systems, where coupling effects between antennas can lead to dynamic impedance changes. Environmental conditions, such as ice buildup, can further exacerbate these fluctuations, making power control more complex. Without proper mitigation, these variations can lead to inefficient power delivery, signal distortion, and increased risk of amplifier failure.

Maintaining a stable power output is desired, as excessive variation can have detrimental effects across multiple applications. In stand-alone amplifiers, uncontrolled power fluctuations can lead to overstressed components, increasing the likelihood of catastrophic failure. In phased-array systems, where beamforming precision relies on maintaining accurate amplitude and phase relationships, deviations in power output can degrade overall system performance. Furthermore, when the amplifier sees a high effective impedance, the transmitted power decreases, limiting signal reach and effectiveness. Given these challenges, ensuring consistent power delivery despite impedance variations is desired for both system reliability and performance. Several approaches exist to mitigate these effects. Among these known techniques, quadrature balanced amplifiers, which operate two parallel amplifiers at half power and in phase quadrature (90° offset), have been widely used to manage impedance mismatches and reflections.

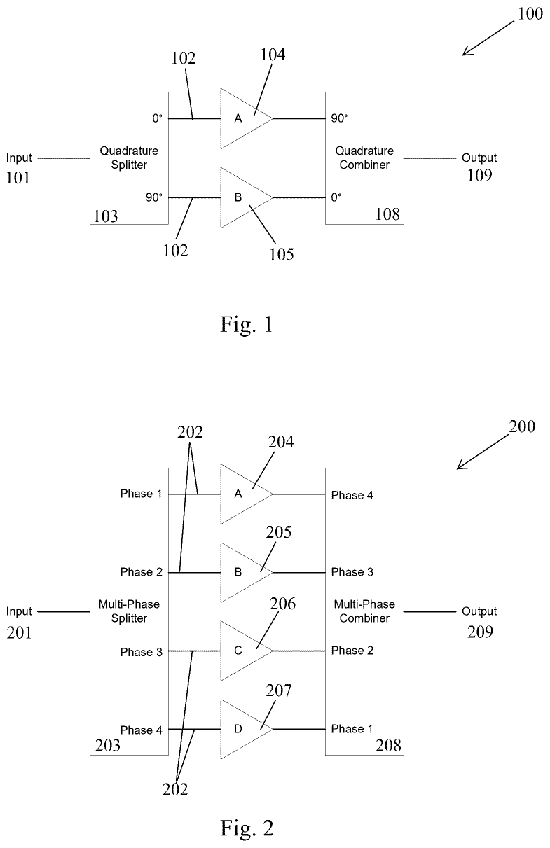

Illustrated in FIG. 1 is an exemplary system for a traditional quadrature balanced amplifier 100. The quadrature balanced amplifier 100 includes a quadrature splitter 103 which divides the input signal 101 into two paths with 0° and 90° offset. The parallel signals 102 are then amplified by two half-amplifiers 104 and 105, and subsequently recombined by a quadrature combiner 104 to restore the original phase alignment at the output 105. The quadrature balanced amplifier 100 provides advantages in terms of mitigating impedance mismatches, as it allows reverse power to be dissipated rather than reflected back into the amplifiers. However, this design is limited in that it uses two amplifiers, meaning that each of the amplifiers experience complementary impedance variations when the load deviates from nominal conditions. In other words, when one sub-amplifier experiences a low impedance relative to the nominal impedance, the second amplifier experiences a high impedance relative to the nominal impedance. Since the power of each half-amplifier is able to deliver is inversely proportional to the impedance of its load, the first half-amplifier will be able to deliver a high power while the second half-amplifier will only be able to deliver a low power. Neglecting the loss of the combiner, the total power will be the sum of the two. Due to the inverse relationship between load impedance and power at a fixed voltage, the delivered power varies with changes in impedance. The variation in power, specifically the spread between the minimum and maximum values, can be reduced compared to a single amplifier or a configuration where two or more sub-amplifiers are connected in parallel and combined in phase.

An important characteristic of a traditional balanced amplifier is that if any reverse power RF signals are reflected back from the sub-amplifiers towards the load, the signals from each sub-amplifier are phase-shifted by an additional 90 degrees, for a total phase shift of 180 degrees. If they are equal-amplitude after they are combined, the signals will destructively interfere and be dissipated in the combiner load instead of being reflected back towards the external load. As such, the traditional balanced amplifier can reduce the level of reflected signals in the system.

Undesirably, the above method does not eliminate power variations entirely or at least sufficiently, as the total delivered power remains sensitive to changing impedance conditions. Additionally, while effective in minimizing reflection-related losses, traditional quadrature balanced amplifiers were not originally designed to address the issue of output power fluctuation due to impedance mismatches. As a result, the output power variation remains undesirably large, which can lead to inefficiencies and instability in high-power RF applications. This instability in power delivery can pose challenges in high-power RF applications, particularly in applications where the load impedance varies dynamically, such as phased-array antennas and broadband communication networks.

To improve upon these limitations, a more advanced power amplifier system is desired. For example, a power amplifier system that can leverage multi-phase amplification, distributes impedance variations across four or more phase-offset sub-amplifiers, and incorporate independent current-limiting power supplies and adaptive power control mechanisms. Such a system may significantly reduce power variation, enhance efficiency, and ensure stable operation in dynamic RF environments. The present disclosure aims to achieve the above by implementing multi-phase amplification with four or more phase-offset sub-amplifiers, each experiencing distinct complex load impedances, along with independent current-limiting power supplies and adaptive power control mechanisms, thereby significantly reducing power variation and enhancing overall system performance. A complex load exists in a circuit where both resistance and reactance (inductive or capacitive effects) influence how current flows. In an amplifier system, complex loads appear at the output of each sub-amplifier, where variations in impedance due to phase shifts and signal combination affect power distribution. This can be common in RF systems, power electronics, and AC circuits, where impedance mismatches can impact efficiency and performance.

The present disclosure provides a RF power amplifier system designed to substantially reduce variations in output power caused by mismatched load conditions. The system achieves this by utilizing multiple sub-amplifiers, each receiving a phase-shifted input signal and generating a corresponding phase-shifted output signal. By strategically applying phase offsets to the input signals and compensating for these offsets at the output, each sub-amplifier experiences a distinct complex load impedance under non-ideal conditions. T his phase management technique can significantly reduce the variability in total output power, thereby improving amplifier performance and reliability in applications where load impedance is highly dynamic.

According to embodiments, the shortcomings may be at least mitigated by introducing a multi-phase amplifier system with four or more sub-amplifiers, distributing impedance variations across multiple paths and optionally incorporating individual current-limiting power supplies and adaptive power control mechanisms to stabilize output power.

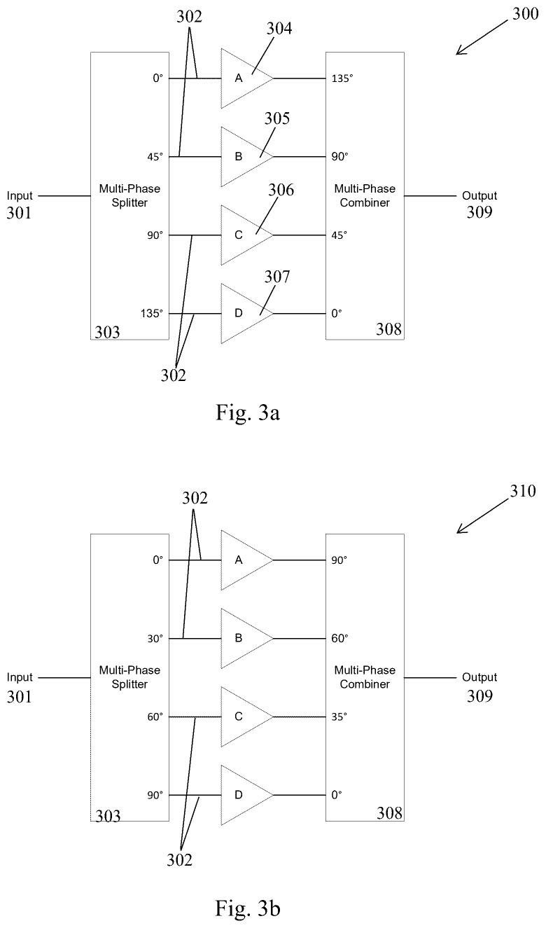

Referring to FIG. 2, a first embodiment is illustrated, showing a generic four-amplifier implementation of the RF power amplifier system 200. As shown, the input signal 201 is divided into four separate signal paths 202, i.e., sub-inputs and sub-outputs, using a multi-phase splitter 203, wherein each signal path 202 receives a distinct phase shift offset. Specifically, the phase-shifted signals are amplified by, for example, four sub-amplifiers 204, 205, 206, 207, each corresponding to specific phase offsets, relative to each other before combining using a multi-phase combiner 208. In an embodiment, each of the multi-phase splitter 203 and the multi-phase combiner 208 may be integrated with its own phase-shifters. Alternatively, one or more phase shifters may be implemented as one or more separate components in the system 200. Specifically, each of the signals is phase-shifted by the multi-phase splitter 203 before being sent to the respective sub-amplifiers 204, 205, 206, 207. The amplified signals are then phase-shifted again, by a complementary or an inverted phase offset, using the multi-phase combiner 208 for generating a combined output 209, such that the total phase shift (e.g. input plus output) for each signal path 202 and each sub-amplifier is equal. This can provide constructive signal combination at the output 209, with the total power being the sum of the individual sub-inputs and sub-outputs, minus any dissipation in the combiner 208. In other words, the sub-outputs of each amplifier are combined such that the phase offset from the input to the output of each amplifier is the same. The mentioned arrangement can ensure that under mismatched load conditions, each sub-amplifier 204, 205, 206, 207 encounters a distinct complex impedance. For example, if the load is a short circuit, a sub-amplifier with a 0° phase shift sees a short circuit, while those with positive(actual) phase shifts experience a positive reactive load, an open circuit, and a negative reactive load, respectively. The forward power each sub-amplifier 204, 205, 206, 207 generates depends on the impedance it encounters. This embodiment can provide modest improvements over the traditional quadrature balanced amplifier system 100 in FIG. 1, as each of the sub-amplifiers 204, 205, 206, 207 experiences a different complex impedance under mismatched load conditions. By distributing impedance variations across four amplifiers instead of two, the system 200 may effectively reduce power fluctuations, making the system 200 particularly suitable for high-power RF transmission applications.

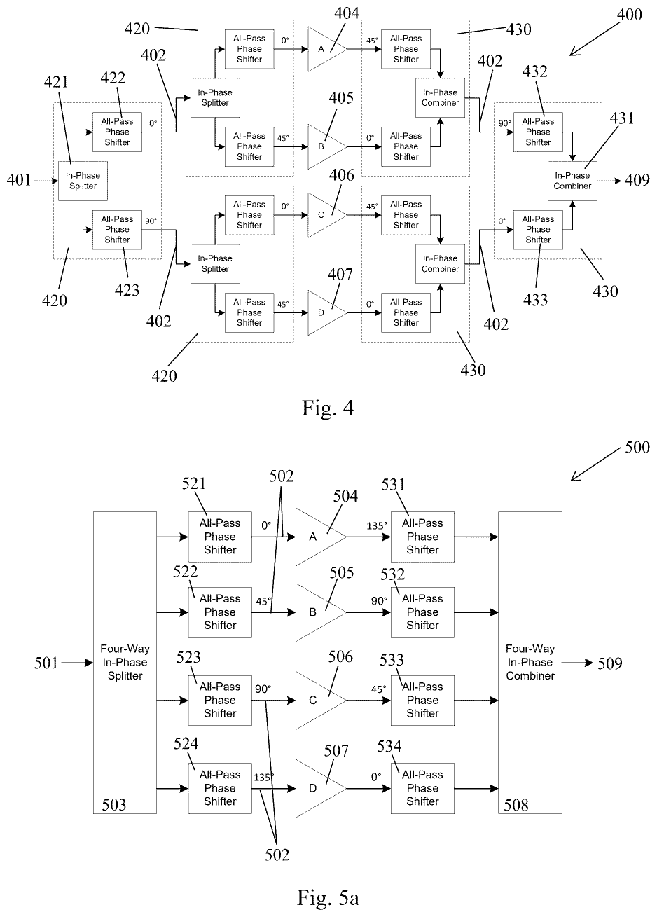

Referring to FIG. 3a, an alternative embodiment is illustrated, implementing a quad-amplifier system 300 implementing a 45° phase shift increment between adjacent sub-amplifiers 304, 305, 306, 307. Similarly, the input signal 301 is divided into four separate signal paths 302, i.e., sub-inputs or sub-outputs, using a multi-phase splitter 303. Unlike FIG. 2, which presents a generic approach, the configuration illustrated in FIG. 3a can result in a more even distribution of impedance variations among the amplifiers, thereby further reducing power fluctuation effects. Specifically, the multi-phase splitter 303 applies nominal phase shifts of 0°-45°-90°-135° to the signal paths 302 before amplification, resulting in phase offsets within a range of 0° to 135°, having a phase variation of nominally 0°-45°-90°-135°. For example, if the load is a short circuit, the amplifier with 0° phase shift sees a short circuit, the amplifier with 45° phase shift sees a positive reactive load, the amplifier with 90° phase shift sees an open circuit, and the amplifier with 135° phase shift sees a negative reactive load. The amplified signals along signal paths 302 are subsequently recombined through a multi-phase combiner 308, which applies complementary or inverted phase shifts, for example, 135°-90°-45°-0° phase offsets, for constructive signal combination to form output 309. The benefit of this approach is a reduction in peak variations in power output, leading to improved efficiency and stability across a wider range of mismatched load conditions.

FIG. 3b illustrates a variation of the system 300 in FIG. 3a. The quad-amplifier system 310 utilizes a 30° phase shift increment among the four sub-amplifiers 304, 305, 306, 307, resulting in phase offsets within a range of 0° to 90° , having a phase variation of nominally 0°-30°-60°-90°. This finer phase resolution further distributes impedance mismatches across the amplifiers, mitigating power deviations even more effectively. As shown, the signals along the four signal paths 302 are nominally phase-shifted by 0°-30°-60°-90° before amplification and then recombined with complementary or inverted phase shifts, for example, 90°-60°-30°-0°. The system 310 can provide superior performance when encountering highly variable load conditions. This embodiment is particularly beneficial in applications requiring stringent power control and signal consistency, such as phased-array radar and high-precision wireless transmission systems. While 0°-45°-90°-135° and 0°-30°-60°-90° phase offsets are two commonly used phase shift configurations, other variations can also be implemented depending on system requirements. By ensuring that no two amplifiers experience identical impedance conditions, this approach can further reduce output power fluctuations and enhance overall system stability. As a practical example, phase-shifting of signals may involve utilizing a signal splitter combined with one or more phase shift networks. A phase shift network incorporates circuit elements and individual phase shifters designed to introduce controlled phase shifts in the signals passing through them while maintaining their amplitude. Phase shift networks may be used to ensure that each sub-amplifier operates with a distinct phase-offset signal, helping to distribute power more evenly and reduce load mismatches. Phase shift networks can be implemented using for example all-pass filters, high-pass/low-pass networks, transmission lines, or quadrature hybrids, depending on the design requirements.

Alternatively, separate signal generators may be employed, where the phase shifts can be introduced either through digital processing or analog techniques. This flexibility in implementation can allow for precise control of phase offsets to optimize power stability and reduce signal distortions under varying load conditions.

In the configurations depicted in FIG. 3a and FIG. 3b, each sub-amplifier may be configured and biased to deliver slightly more than one-quarter of the desired total output power when operating at nominal impedance. When combined, these configurations can achieve the target output power with an additional margin to accommodate variations. When operating with a mismatched load, each sub-amplifier encounters a distinct complex load, resulting in varying power contributions. However, because the phase is evenly distributed, one or more of the amplifiers will deliver less than their nominal power while others will deliver more. As a result, the total power output remains closer to the nominal power than if all sub-amplifiers experienced the same load.

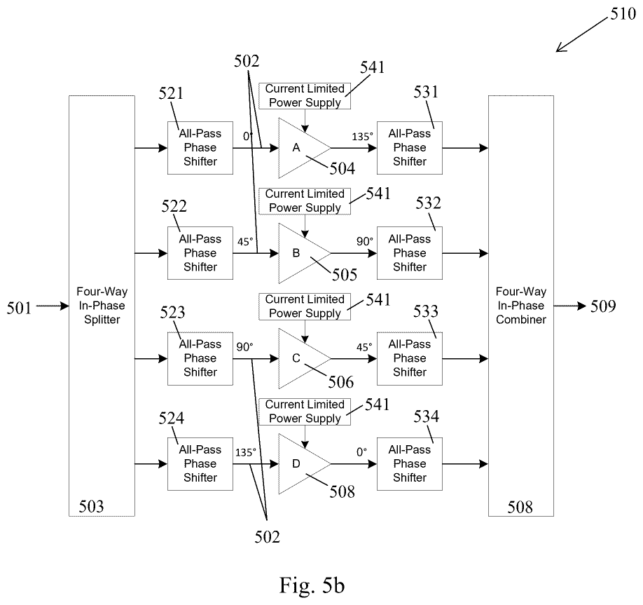

The method of obtaining phase offsets can be flexible, allowing for various configurations to achieve the desired effect. A particularly convenient approach utilizes two-way in-phase power splitters and combiners in conjunction with phase shift networks, as illustrated in FIG. 4. Specifically, the system 400 employs multiple cascaded two-way splitters 420 and two-way combiners 430 to distribute and recombine signals efficiently. Within each two-way splitter 420, an in-phase splitter 421 divides the input signal 401 into two signal paths 402, with phase shifters 422 and 423 introducing a controlled phase offset, for example, 0°-90°. These signals are further split and phase-shifted at 0°-45° through additional cascaded splitters 420, generating four phase-offset signal paths 402, which are subsequently amplified by sub-amplifiers 404, 405, 406, and 407.

After amplification, the phase-offset signals are recombined to form the final output 409. This recombination process occurs progressively through cascaded two-way combiners 430, each integrating an in-phase combiner 431 along with phase shifters 432 and 433 to maintain the required phase relationships, such that the total phase shift (e.g. input plus output) for each signal path 402 is equal. This modular architecture can enhance design flexibility and provide compatibility with commercially available quadrature hybrids and power dividers. Additionally, 90° splitters 420 and combiners 430 can be implemented using quadrature hybrids or other inherent quadrature topologies, offering alternative means to achieve precise phase offsets.

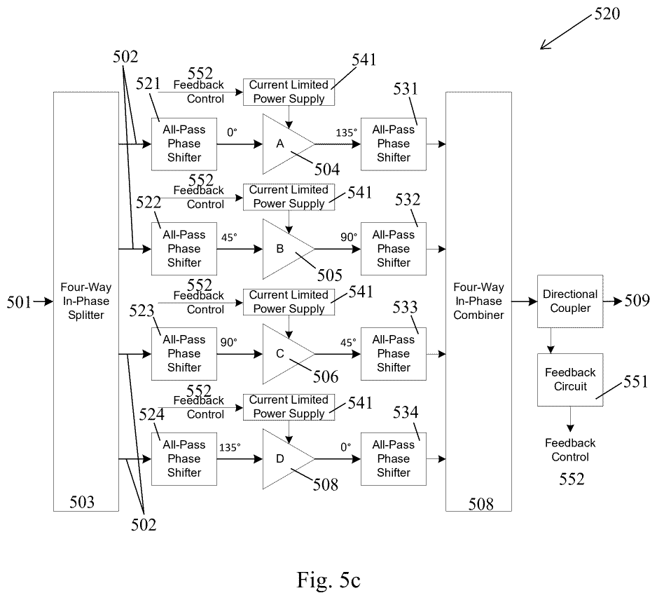

Alternatively, rather than employing a cascade of two-way splitters and combiners, an n-way splitter and/or n-way combiner can be used in combination with n number of different phase shift networks, as illustrated in FIG. 5a. According to system 500, a four-way in-phase splitter 503 is used to directly divide the input signal 501 into four signal paths 502, eliminating the need for cascaded splitters. Before amplification, the divided signals will undergo a phase-offset, for example, 0°-45°-90°-135°, by a first set of phase shifters 521, 522, 523, 524 respectively. After passing through the sub-amplifiers 504, 505, 506, 507 the amplified signals will undergo a complementary or inverted phase-offset, for example, 135°-90°-45°-0°, by a second set of phase shifters 531, 532, 533, 534 and subsequently combined by a four-way in-phase combiner 508 to generate final output 509. As would be appreciated, the phase shifters may be integrated into the four-way splitter 503 and the four-way combiner 508, respectively. As shown, the four-way in-phase combiner 508 and phase shifters 531, 532, 533, 534 are used to aggregate the amplified signals while maintaining phase alignment across all the signal paths 502, such that the total phase offset (e.g. input plus output) for each signal path 502 is equal. The configuration according to system 500 can simplify the network architecture by reducing the number of elements while still enabling each signal path to experience the required phase shift. It should be noted that the choice of splitter and combiner topology can be made independently. For example, the combiner can be a cascade of two-way combiners or an n-way combiner, regardless of the topology used for the splitter.

It would be appreciated that the phase shift networks themselves can be implemented using various circuit configurations, such as all-pass networks, high-pass/low-pass networks, and transmission lines. Each of these implementations can offer different advantages depending on design constraints, bandwidth requirements, and impedance matching considerations. Furthermore, the order of the splitters and combiners is not critical, provided that the total phase shift in each path remains the same, thereby providing proper phase alignment across the amplifier system.

In practical implementations, many phase shift networks can provide the nominal phase shift only when both the source and load impedances match the expected nominal values. However, when there is a significant impedance mismatch, the actual phase shift can deviate substantially from the nominal value. While this deviation may introduce some performance degradation in amplifiers using this technique, the overall system performance can be superior when compared to a system without phase shifts. Advantageously, employing a smaller overall phase variation, such as 0°-30°-60°-90°, may yield better performance than using an optimally calculated phase variation of 0°-45°-90°-135°, as the former can help mitigate excessive deviations caused by impedance mismatches. Furthermore, the phase shifters employed in the present disclosure can primarily serve to modify the phase of the signal passing through each sub-amplifier while maintaining a consistent amplitude of the load. In general, this means that while the individual sub-amplifiers experience different phase angles, the magnitude of their respective loads remains the same. This phase variation can enable the power to be more evenly distributed among the amplifiers, reducing the likelihood of excessive power contributions from any single sub-amplifier due to load mismatches.

As discussed in the foregoing, the phase shift approach can reduce power variation caused by mismatched loads, but further improvement can be achieved by powering each sub-amplifier with its own current-limiting power supply, as illustrated in FIG. 5b. As shown, system 510 has essentially an identical arrangement to that of system 500, with the only difference being that each of the sub-amplifiers 504, 505, 506, 507 are powered by an independent current-limiting power supply 541. The current-limiting power supply 541 operates in constant voltage mode under high-impedance conditions and transitions to constant current mode under low-impedance conditions, thereby preventing excessive current draw and improving power stability. By independently regulating each amplifier's power supply, this embodiment an enhance system reliability, preventing amplifier failures due to overcurrent conditions. Advantageously, this configuration does not affect sub-amplifiers that experience a nominal or higher-than-nominal impedance load. However, for sub-amplifiers subjected to significantly lower impedance loads, the current-limiting power supply can reduce the supplied voltage. Since impedance and power are inversely related when operating at a fixed voltage, sub-amplifiers encountering a low-impedance load would otherwise contribute disproportionately high power to the system. By reducing the voltage to these amplifiers in order to maintain a constant current within a set limit, the excessive power contribution from low-impedance paths can be mitigated or reduced. This can result in a narrower spread between the minimum and maximum power levels for a given load mismatch.

Furthermore, the variation in forward power can be further minimized, and in many cases nearly eliminated, by adaptively adjusting the drain or collector voltages of the sub-amplifiers. Illustrated in FIG. 5c. is a further embodiment incorporating the above techniques. Based on systems 510 and 500, the RF power amplifier system 520 further incorporates a directional coupler 551 and an adaptive power control circuit 552, or a feedback circuit. The directional coupler 551 monitors forward and reverse power, generating a real-time feedback control signal 553 that is processed by the adaptive power control circuit 552. Based on the feedback control signal 553, the adaptive power control circuit 552 can be configured to adjust voltage output of the current-limiting power supply 541 of each of the amplifiers 504, 505, 506, 507 dynamically in order to maintain a predefined target output level. The directional coupler 551 distinguishes between forward and reverse power, whereas the forward power is used as a metric for maintaining stable operation. In a practical implementation, each amplifier may be initially biased at a predefined drain or collector voltage, and the output power may be sampled shortly after the input signal is applied. If the measured output power deviates from the target, an adjusted voltage may be estimated and applied.

In some embodiments, the feedback operation may be iterated until the output power aligns with the desired level within an acceptable tolerance. In other words, the adaptive power control circuit 552 can iteratively adjust the voltages of the sub-amplifiers to converge to the predetermined target power of the output signal. Given the predictable relationship between voltage and power, only a few iterations may be required to converge on the target power. By iteratively refining the power distribution among sub-amplifiers, this embodiment can provide a more stable output power under almost all load conditions and compensate for impedance mismatches in real time. This implementation can be well-suited for high-precision RF transmission applications where power stability and efficiency are critical.

According to embodiments, the most straightforward way to implement this adaptive power control is by uniformly varying the drain or collector voltages of all sub-amplifiers. However, further refinements in both performance and efficiency can be achieved by individually adjusting the bias voltage for each sub-amplifier. This tailored approach can account for the specific impedance conditions experienced by each amplifier, leading to a more optimized power distribution and improved overall system efficiency.

The RF power amplifier system according to the present disclosure can provide a significant improvement over traditional designs by incorporating multi-phase signal processing, independent current-limiting power supplies, and adaptive power control mechanisms. These techniques and features can enable greater power stability, improved efficiency, and enhanced reliability in applications where load impedance varies dynamically, such as phased-array antennas, broadband RF transmission, and high-power communication systems. The disclosed RF power amplifier system and method can provide a significant advancement over conventional amplifier designs. By employing phase-shifted sub-amplifiers, independent current-limiting power supplies, and adaptive power control, the invention can achieve a superior stability and efficiency under varying load conditions.

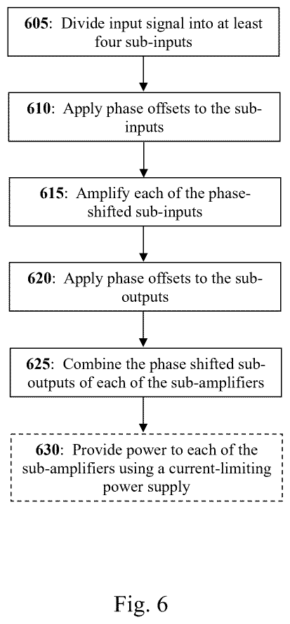

FIG. 6 illustrates a method for amplifying a radio frequency signal according to embodiments. The method includes dividing 605, an input signal into at least four sub-inputs, each having the same frequency and nominal amplitude and applying 610, phase offsets to the sub-inputs, such that the sub-inputs are phase-shifted relative to each other within a predefined phase variation. The method further includes amplifying 615, each of the phase-shifted sub-inputs with a sub-amplifier to generate corresponding sub-outputs and applying 620, phase offsets to the sub-outputs, such that the total phase offsets for each of the sub-inputs and the corresponding sub-outputs are equal. The method further includes combining 625, the phase shifted sub-outputs of each of the sub-amplifiers to generate an output signal. Each of the sub-amplifiers is presented with a different complex load impedance under mismatched load conditions.

In some embodiments, the phase offsets are within the range of 0° to 135°, having a phase variation of 0°-45°-90°-135°. In some embodiments, the phase offsets are with the range of 0° to 90°, having a phase variation of 0°-30°-60°-90°.

In some embodiments, the dividing is performed by a cascaded two-way splitter or is implemented using quadrature hybrids. In some embodiments, the combining is performed by a cascaded two-way combiner or is implemented using quadrature hybrids.

In some embodiments, the method further includes providing 630, power to each of the sub-amplifiers using a current-limiting power supply configured to provide constant voltage during high impedance loads and transition to constant current during low impedance loads.

In some embodiments, the method further includes sampling the output power of the combined output signal to generate a feedback control signal and adjusting the voltages supplied to each of the sub-amplifiers based on the feedback control signal to maintain a predetermined target power of the output signal.

In some embodiments, the method further includes iteratively adjusting the voltages of the sub-amplifiers to converge to the predetermined target power of the output signal.

In some embodiments, the method further includes adjusting the initial drain or collector voltage of each sub-amplifier individually to optimize efficiency and performance under varying load conditions.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A radio frequency power amplifier system, comprising:
a splitter configured to divide an input signal into a plurality of sub-inputs of same frequency and nominal amplitude,
a first phase shift network configured to apply phase offsets to the sub-inputs, such that the sub-inputs are phase-shifted relative to each other;
at least four parallel arranged sub-amplifiers, the parallel arranged sub-amplifiers configured to be driven by the sub-inputs and generate sub-outputs;
a second phase shift network configured to apply the phase offsets inversely to the sub-outputs, such that a total phase offset is equivalent for each of the sub-amplifiers; and
a combiner configured to combine the sub-outputs into an output signal;
wherein, each of the sub-amplifiers is presented with a different complex load impedance under mismatched load conditions.

2. The radio frequency power amplifier system of claim 1, wherein the phase offsets are within the range of 0° to 135°, having a phase variation of nominally 0°-45°-90°-135°.

3. The radio frequency power amplifier system of claim 1, wherein the phase offsets are with the range of 0° to 90°, having a phase variation of nominally 0°-30°-60°-90°.

4. The radio frequency power amplifier system of claim 1, wherein the output combiner comprises an n-way combiner configured to aggregate the phase-shifted sub-outputs of the sub-amplifiers.

5. The radio frequency power amplifier system of claim 1, wherein the splitter is configured as a cascaded two-way splitter or is implemented using quadrature hybrids.

6. The radio frequency power amplifier system of claim 1, wherein the combiner is configured as a cascaded two-way combiner or is implemented using quadrature hybrids.

7. The radio frequency power amplifier system of claim 1, wherein each of the sub-amplifiers includes a current-limiting power supply configured to provide constant voltage during high impedance loads and transition to constant current during low impedance loads.

8. The radio frequency power amplifier system of claim 1, further comprising an adaptive power control circuitry configured to adjust the voltages supplied to each of the sub-amplifiers based on sampling the power of the output signal.

9. The radio frequency power amplifier system of claim 8, wherein the adaptive power control circuitry generates a feedback control signal to each of the current-limiting power supplies and iteratively adjusts the feedback control signals to converge to a predetermined power target of the output signal.

10. The radio frequency power amplifier system of claim 9, wherein the adaptive power control circuitry adjusts initial drain or collector voltage of each of the sub-amplifiers individually to optimize performance and efficiency under varying load conditions.

11. The radio frequency power amplifier system of claim 1, further comprising a directional coupler configured to distinguish between forward and reverse power, wherein forward power is used as a metric for maintaining stable operation.

12. A method of amplifying a radio frequency signal, the method comprising:
dividing an input signal into at least four sub-inputs, each having the same frequency and nominal amplitude;
applying phase offsets to the sub-inputs, such that the sub-inputs are phase-shifted relative to each other within a predefined phase variation;
amplifying each of the phase-shifted sub-inputs with a sub-amplifier to generate corresponding sub-outputs;
applying phase offsets to the sub-outputs, such that the total phase offsets for each of the sub-inputs and the corresponding sub-outputs are equal; and
combining the phase shifted sub-outputs of each of the sub-amplifiers to generate an output signal;
wherein each of the sub-amplifiers is presented with a different complex load impedance under mismatched load conditions.

13. The method of claim 12, wherein the phase offsets are within the range of 0° to 135°, having a phase variation of 0°-45°-90°-135°.

14. The method of claim 12, wherein the phase offsets are with the range of 0° to 90°, having a phase variation of 0°-30°-60°-90°.

15. The method of claim 12, wherein the dividing is performed by a cascaded two-way splitter or is implemented using quadrature hybrids.

16. The method of claim 12, wherein the combining is performed by a cascaded two-way combiner or is implemented using quadrature hybrids.

17. The method of claim 12, further comprising providing power to each of the sub-amplifiers using a current-limiting power supply configured to provide constant voltage during high impedance loads and transition to constant current during low impedance loads.

18. The method of claim 17, further comprising sampling the output power of the combined output signal to generate a feedback control signal and adjusting the voltages supplied to each of the sub-amplifiers based on the feedback control signal to maintain a predetermined target power of the output signal.

19. The method of claim 18, further comprising iteratively adjusting the voltages of the sub-amplifiers to converge to the predetermined target power of the output signal.

20. The method of claim 19, further comprising adjusting the initial drain or collector voltage of each sub-amplifier individually to optimize efficiency and performance under varying load conditions.
